(19) United States
(12) Patent Application Publication
(10) Pub. No.: US 2007/0278390 A1
(43) Pub. Date: Dec. 6, 2007

(54) Detectors and actuating devices incorporating same

(75) Inventor: Torsten Wipiejewski, New Territories (CN)

Correspondence Address: BUCHANAN, INGERSOLL & ROONEY PC, POST OFFICE BOX 1404, ALEXANDRIA, VA, 22313-1404, US

(73) Assignee: HONG KONG APPLIED SCIENCE AND TECHNOLOGY RESEARCH INSTITUTE CO. LTD., New Territories (CN)

(21) Appl. No.: 11/447,071

(22) Filed: Jun. 6, 2006

(51) Int. Cl. G06M 7/00

(52) U.S. Cl. 250/221

(57) ABSTRACT

A detector for detecting the presence of an object at a prescribed location, the detector comprising:—
an optical source arranged for emitting a collimated optical beam towards the prescribed location,
an optical detector for detecting optical signals emitted by said optical source,
an optical collector arranged for collecting optical beams scattered by an object located at the prescribed location and for forwarding said optical beams to said optical detector for optical detection; and
control circuitry for monitoring output of said optical detector and for determining the presence or absence of an object at said prescribed location by monitoring said output.

### FIELD OF THE INVENTION

This invention relates to detectors and, more particularly, to an optical detector for detecting the presence of an object at a location by optical means. This invention also relates to an actuation device incorporating an optical detector.

### BACKGROUND OF THE INVENTION

Many machines or apparatus are equipped with key-pad type actuation devices for human control and interaction. For example, ATMs (automatic teller machines) and lifts comprise a key-pad type actuation device for a user to operate the machine. A high precision numerical control cutting machine, such a CNC machine, is equipped with a keypad-type actuation device for input of control parameters. Typically, an actuation device is finger operated so that upon detection of a sequence of key movements, for example, a sequence of key depressions, the commands input by a user can be recognised.

With the increasing concern of health risk, for example, contraction of infectious diseases, such as SARS (Severe Acute Respiratory Syndrome), atypical pneumonia, avian flu or other contagious disease due to finger contact, operation of public appliances using finger contact is less desirable. However, finger operated apparatus control is still regarded as the most flexible and convenient. Hence, it will be beneficial if improved detectors or finger operated actuation devices can be provided to alleviate shortcomings of conventional finger operated key-pad type controls or actuation devices while allowing flexibility of finger operation.

### SUMMARY OF THE INVENTION

Broadly speaking, the present invention has described a detector for detecting the presence of an object at a prescribed location, wherein the detector comprises an optical source arranged for emitting a collimated optical beam towards the prescribed location, an optical detector for detecting optical signals emitted by said optical source, an optical collector arranged for collecting optical beams scattered by an object located at the prescribed location and for forwarding said optical beams to said optical detector for optical detection; and control circuitry for monitoring output of said optical detector and for determining the presence or absence of an object at said prescribed location by monitoring said output.

An optical detection arrangement of this invention provides a flexible optical detection means in which a prescribed location for actuation triggering can be adjusted. For example, the prescribed location can be adjusted to be nearer or further away from the optical detector by varying the spatial relationship between the optical detector and the optical collector. This arrangement facilitates a non-contact actuation of devices which would otherwise require finger contact operation.

In a preferred embodiment, the optical detector is a module with the optical source and the optical detector disposed within an enclosure. More particularly, the optical source is arranged for emitting a collimated beam out of the enclosure and towards the prescribed location, the prescribed location is outside the enclosure, the optical collector forms a light collecting window intermediate the prescribed location and the detector and is adapted for forwarding the collimated beam after being scattered by said object to said optical collector. The use of a collimated beam enhances positioning accuracy which is especially important for a high-density switch array. A modular design of the optical detector facilitates flexible deployment for multiple-switch applications which are beneficial for many practical purposes.

In an exemplary embodiment, said prescribed location, said optical collector and said optical detector are arranged on a line-of-sight. In an exemplary arrangement, said prescribed location and said optical source are on a line-of-sight and wherein said optical source and said optical detector are not on a line-of sight.

In one preferred embodiment, the optical source and the optical detector are disposed within an enclosure, said optical source is arranged for emitting a collimated beam out of said enclosure and said prescribed location is outside the enclosure; and wherein the optical collector forms a light collecting window intermediate said prescribed location and said detector and being for forwarding the collimated beam after being scattered by said object to said optical collector. The use of a collimated beam would enhance positioning accuracy while making the detector less prone to external and/or adverse stray light interference.

Preferably, said optical collector comprises an optical aperture on said enclosure. The optical aperture is configured so that only light from a predefined location will be collected by the optical detector.

In an exemplary configuration, said optical aperture is on a line of sight between said prescribed location and said optical detector. In this configuration, both a light emitting surface of said optical source and a light detecting surface of the optical detector are opposite of said prescribed location.

Preferably, said optical source is adapted for emitting a laser beam towards said prescribed location for subsequent scattering by said object towards said optical collector. As a convenient example, said optical source may comprise a modulated laser transmitter. More specifically, the laser transmitter may comprise a VCSEL laser emitter. The VCSEL laser may further comprise an optical feedback loop for stabilization of the laser transmitter. The use of a laser or other coherent light source will operate to mitigate adverse influence, for example, mitigates stray light interference and therefore enhances spatial accuracy.

In a preferred embodiment, said optical detector comprises a plurality of photo-detecting cells, outputs of the photo-detecting cells are compared for determining the presence of an object at the prescribed location. Preferably, outputs of said plurality of photo-detecting cells are differentially compared. The use of differential outputs further enhances measurement accuracy since common mode noise will be substantially reduced. More specifically, the detector further comprises decision circuitry for differentially comparing outputs of the photo-detecting cells.

Preferably, the plurality of detectors are arranged in a matrix or in an array. To provide further convenience to a user, each said detector has an associated visual indicator. Preferably, said visual indicator comprises alphabets or numerals on back illumination.

In practice, the array defines a plurality of actuation locations, each actuation location coincides with the prescribed locations of the detectors, the actuation locations of the object detectors do not overlap.

To be more user friendly, each object detector is arranged for emitting a visual acknowledgement signal when an object is detected as being present at said prescribed location of that object detector. Preferably, each of the object detectors is adapted for detecting the presence of a finger at the prescribed location of that detector for non-contact actuation operation. This facilitates a convenient non-contact actuation of control buttons.

In an exemplary application, a target apparatus requires a set of sequential activation codes and, therefore, said actuation device is adapted for sequential operation of a plurality of keys by detecting sequential presence of a finger at a plurality of prescribed locations.

In many instances, the detector is deployed for finger activation applications. Therefore, it is preferred that said optical collector is adapted for collecting light scattered by the head portion of a finger after a collimated light from said optical source having impinged on said head portion of said finger.

In one preferred embodiment, said optical source, the finger and said optical detector are arranged to form a closed optical detection loop when said finger is placed at said prescribed location whereat light emitted by the optical source being scattered by said finger and collected by said optical detector to complete said optical detection loop, said optical detection loop being opened when said finger is removed from said prescribed location.

### BRIEF DESCRIPTION OF THE DRAWINGS

Preferred embodiments of the present invention will be explained in further detail below by way of examples and with reference to the accompanying drawings, in which:—

FIG. 1 illustrates a preferred embodiment of an optical detector of this invention demonstrated with a finger located at a prescribed location,

FIG. 2 illustrates an optical detector of a second preferred embodiment of this invention,

FIG. 3 illustrates the optical characteristics of the two photo-detector cells in the optical detector of FIG. 2,

FIG. 4 is a schematic circuit diagram showing the optical detector of FIG. 2,

FIG. 5 shows an actuation device incorporating a plurality of optical detectors of FIG. 2,

FIG. 6 illustrates schematically the key-pad actuation device with the plurality of optical detectors arranged in a 4×3 array, and

FIG. 7 illustrates an exemplary operation of the 4×3 switch pad of FIGS. 5 and 6.

### DETAILED DESCRIPTION OF THE PREFERRED EMBODIMENTS

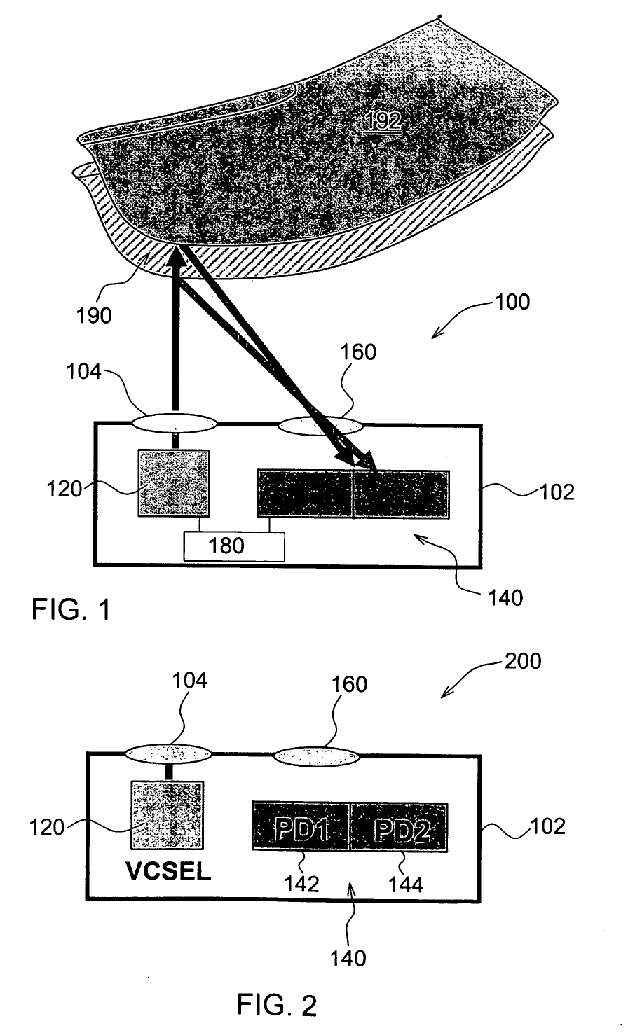

Referring to FIG. 1, there is shown an optical detector for detecting the presence of an object at a prescribed location. The optical detector 100 comprises an optical source 120, an optical detector 140, an optical collector 160 and control circuitry 180. The optical source is arranged for emitting a collimated optical beam, such as a laser beam, towards a prescribed location 190. More particularly, the optical detector is arranged for detecting optical signals emitted by the optical source. The optical collector is arranged for collecting optical beams scattered by an object 192 when located at the prescribed location 190 and for forwarding the optical beams to the optical detector for optical detection. The control circuitry 180 is provided for monitoring output of the optical detector and for determining the presence or absence of an object at the prescribed location by monitoring the output of the optical detector. In addition, the control circuitry also generates a control signal for control output upon a positive detection of an object at the prescribed location. An optical source comprising an collimated beam source such as a laser source is used as this will provide enhanced detection precision.

As FIG. 1 illustrates the optical detector in operation when a finger 192 is placed at a prescribed location 190. Referring to FIG. 1, the optical source, the optical detector and the optical collector are arranged so that the collimated light emitted by the optical source is deflected due to scattering by an object (the finger in this example) towards the optical collector for subsequent collection by the optical collector. In the course of the scattering, the collimated light beam is deflected by more than 90° so that the direction of travel of the collimated beam is substantially reversed and deflected by between 90° and 180°. The optical detector 100 is in a module form comprising a module housing 102 in which the optical source and the optical detector are accommodated. The optical source is in optical communication with the prescribed location via a transparent window 104 such that the prescribed location, the transparent window and the light emitting services of the optical source are in a line of sight. Likewise, the light detection surface of the optical detector 140 and the prescribed location are in optical communication via the optical collector 160 which comprises a transparent window so that the prescribed location, the transparent window and the optical detection surfaces are in a line of sight arrangements. However, the light emitting surface of the optical source and the light detecting surfaces of the optical detector are not on a line of sight.

As shown more particularly in FIG. 1, the optical source is arranged so that a collimated beam is emitted towards the prescribed location during operation. To ensure a high spatial operation accuracy, that is, a positive detection only if an object is placed at an exact location, the collimated beam has a light spot of a relatively small size, for example, with a spot diameter of less than 1 mm. The optical collector is disposed on the housing for providing an optical interface between the prescribed location and the optical detector. The optical collector may comprise a lens (for example, a convex lens, a concave lens) or a pin-hole so that light scattered by an object can be collected by the optical detection surfaces of the optical detector, similar to the operation of a camera. When an object is placed or located at the prescribed location, the collimated light beam will be scattered in a plurality of directions towards the optical collector for forwarding to the optical detector. When a finger or an object is not present at the prescribed location, the collimated beam will travel away from the optical detector and, since the collimated beam is no longer scattered towards and collected by the optical detector, no positive optical detector will be output by the optical detector.

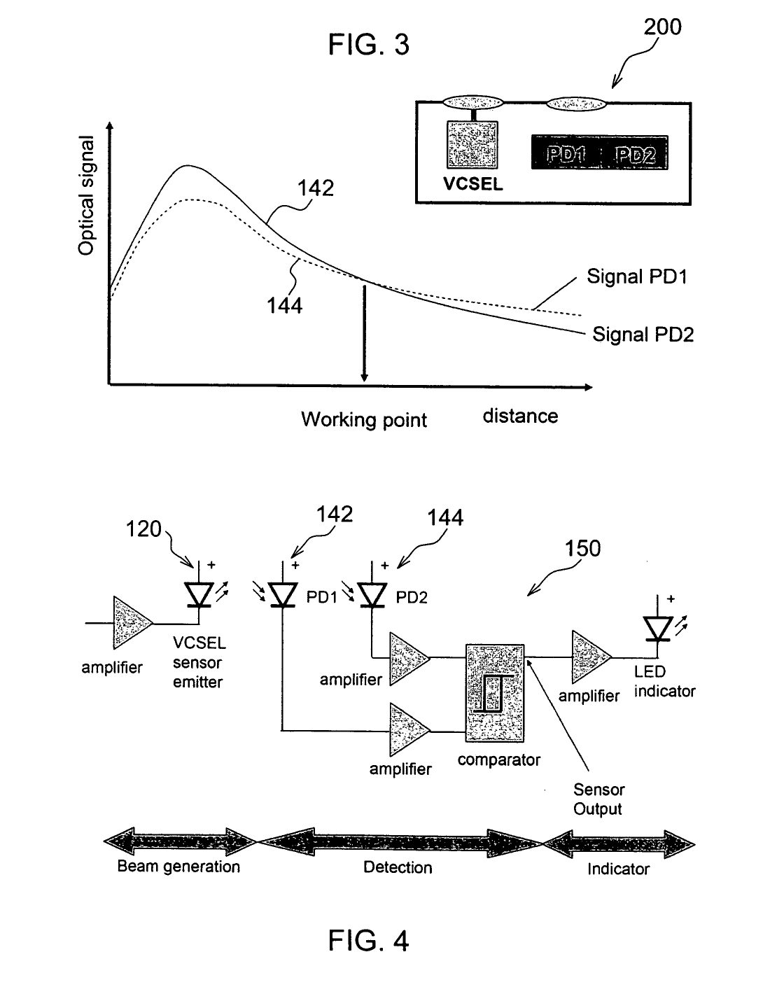

In FIG. 2, there is shown an optical detector 200 illustrating a second preferred embodiment of this invention. This preferred embodiment of the photo-detector comprises a plurality (two in this example) of photo-detector cells placed side-by-side. The other parts are the same as that of the first preferred embodiment and are designated with the same numerals. As shown in FIG. 1 and the chart of FIG. 3, the photo-detection by the two photo-detector cells, namely, PD1 (142) and PD2 (144), follow a detection characteristic of FIG. 3 depending on the distance of the object away from the photo-detectors. By selecting an appropriate working point, a more precise location of an object can be detected by the use of an appropriate comparison circuitry as shown in FIG. 4.

Referring to the schematic circuit diagram of FIG. 4, the photo-detector cells are designated PD1 and PD2. By comparing the outputs of PD1 and PD2 with reference to the operating point characteristics of PD1 and PD2, a more precise location of the object away from the photo-detector can be measured by a differential output of the PD1 and PD2. The use of a comparison arrangement, and more specifically a differential output arrangement 150, provides an enhanced location specific detection device for useful applications.

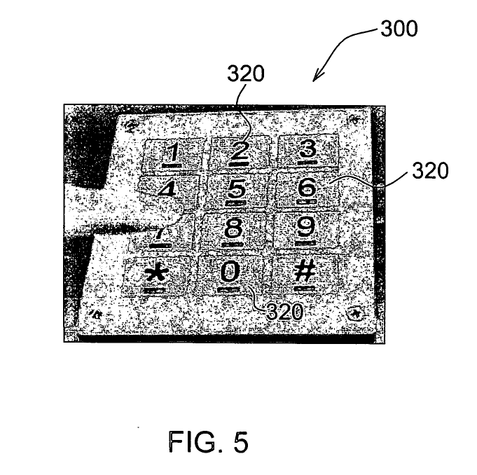

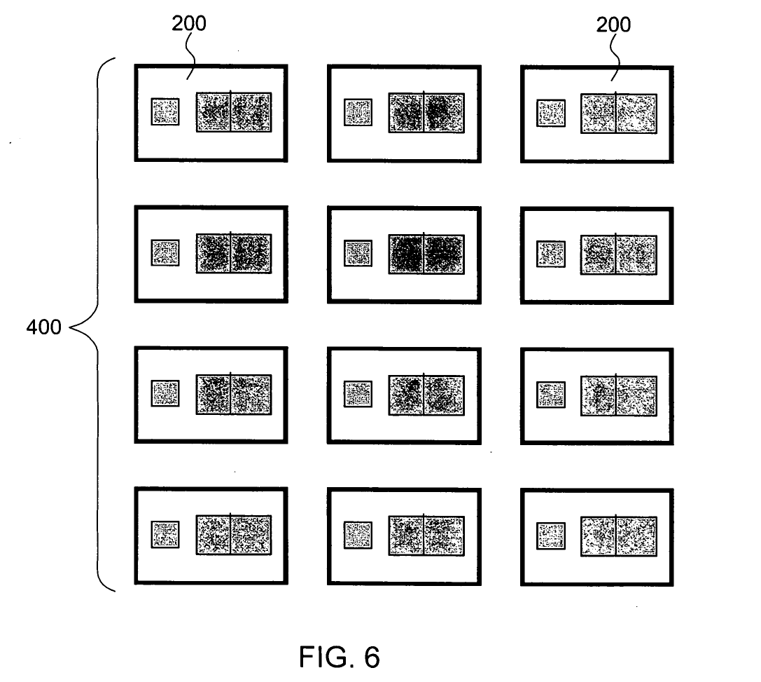

An exemplary application of the optical detectors in finger operated actuating devices are illustrated in FIGS. 5 to 7. Referring to FIGS. 5 to 7, the actuating device 300 comprises a plurality of finger operated keys 320 with alpha-numeral designation of 0-9, * and #. The alpha-numerical keys are arranged in a 4×3 array with keys 1, 2, 3 in the first row, 4, 5, 6 in the second row and etc. Each of the actuation keys is delineated within a box and has an associated back illumination light which operates to indicate when a particular key has been selected or activated. The array of actuation keys 400 comprising 12 optical detectors 200 is shown in FIG. 6.

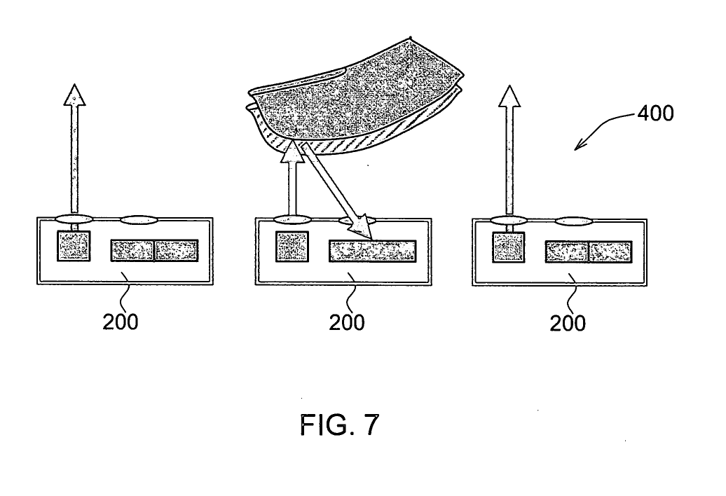

An exemplary operation of the actuation device of FIGS. 5 an 6 will be illustrated with reference to FIG. 7 in which a view of three actuation keys each comprising an optical detector of this invention will be illustrated. During operation, the optical source of each of the optical detectors emits a collimated beam towards their corresponding prescribed locations. The optical sources are arranged so that a plurality of collimated beams are emitted along a direction which is orthogonal to the common plane of the key pad, that is, orthogonally upwards from FIG. 6. When an object, for example, a finger, is present at a prescribed location which is directly above the optical detector, scattering of the collimated beam by the finger will divert light towards the optical collector which further forwards the light towards the optical detectors. By monitoring the output of an optical detector, which may comprise a photo-detector or a plurality of photo-detectors, the presence or absence of a finger at the prescribed location can be decided.

To further improve the precision of the location detectablity, instead of measuring the output from the photo-detector or the photo-detectors, the differential output from a pair of photo-detectors within the same optical detector is compared so that a key will be actuated only when a finger is present at precisely the prescribed locations. As can be seen from FIG. 7, when the finger is placed at a prescribed location of the middle key, light emitted by the two adjacent keys on the left and right sides of the centre key will not be scattered by the finger, thereby mitigating the risk of false actuation. Once a particular key has bee activated, the control circuitry will cause back illumination of the key to indicate to a user that the particular key has been actuated so that the user can take remedial steps in case a wrong key has bee accidentally triggered. In this example, the optical source comprises a laser source with a spot size of less than 1 mm in diameter when at a prescribed location which is at a distance of 15 mm away from the optical source for enhanced accuracy. The optical collector comprises a pin-hole or an appropriate lens for focusing scattered light onto the pair of photo-detectors. Although a pair of photo-detector cells are preferred in order to have a differential output for improved accuracy, it will be understood that the optical detector can operate with a single photo-detector cell by monitoring the output level without loss of generality.

By incorporating optical detectors in the actuation device of FIGS. 5-7 and by arranging the optical arrangement so that the prescribed location is above the plane of the key-pad, non-contact actuation can be achieved using a relatively simple key array arrangements.

While the present invention has been explained by reference to the examples or preferred embodiments described above, it will be appreciated that those are examples to assist understanding of the present invention and are not meant to be restrictive. Variations or modifications which are obvious or trivial to persons skilled in the art, as well as improvements made thereon, should be considered as equivalents of this invention.

Furthermore, while the present invention has been explained by reference to optical detectors and finger operated actuation devices, it should be appreciated that the invention can apply, whether with or without modification, to other actuation devices without loss of generality.

1. A detector for detecting the presence of an object at a prescribed location, the detector comprising:—
an optical source arranged for emitting a collimated optical beam towards the prescribed location,
an optical detector for detecting optical signals emitted by said optical source,
an optical collector arranged for collecting optical beams scattered by an object located at the prescribed location and for forwarding said optical beams to said optical detector for optical detection; and
control circuitry for monitoring output of said optical detector and for determining the presence or absence of an object at said prescribed location by monitoring said output.

2. A detector according to claim 1, wherein said optical source, said optical detector and said optical collector are arranged so that the light emitted by said optical source is deflected by more than 90 degrees after being scattered by an object located at said prescribed location for collection by said optical collector.

3. A detector according to claim 2, wherein said prescribed location, said optical collector and said optical detector are arranged on a line-of-sight.

4. A detector according to claim 3, wherein said prescribed location and said optical source are on a line-of-sight and wherein said optical source and said optical detector is not on a line-of sight.

5. A detector according to claim 1, wherein the optical source and the optical detector are disposed within an enclosure, said optical source is arranged for emitting a collimated beam out of said enclosure and said prescribed location is outside the enclosure; and wherein the optical collector forms a light collecting window intermediate said prescribed location and said detector and being for forwarding the collimated beam after being scattered by said object to said optical collector.

6. A detector according to claim 5, wherein said optical collector comprises an optical aperture on said enclosure.

7. A detector according to claim 6, wherein said optical aperture is on a line of sight between said prescribed location and said optical detector.

8. A detector according to claim 6, wherein both a light emitting surface of said optical source and a light detecting surface of the optical detector are opposite of said prescribed location.

9. A detector according to claim 5, wherein said optical source is adapted for emitting a laser beam towards said prescribed location for subsequent scattering by said object towards said optical collector.

10. A detector according to claim 5, wherein said optical source comprises a modulated laser transmitter.

11. A detector according to claim 10, wherein the laser transmitter comprises a VCSEL laser emitter.

12. A detector according to claim 11, wherein, wherein said VCSEL laser comprises an optical feedback loop for stabilization of the laser transmitter.

13. A detector according to claim 1, wherein said optical detector comprises a plurality of photo-detecting cells, outputs of the photo-detecting cells are compared for determining the presence of an object at the prescribed location.

14. A detector according to claim 13, wherein the outputs of said plurality of photo-detecting cells are differentially compared.

15. A detector according to claim 14, further comprising decision circuitry for differentially comparing outputs of the photo-detecting cells.

16. An actuation device comprising a plurality of detectors of claim 1, wherein the plurality of detectors are arranged in a matrix or in an array.

17. An actuation device according to claim 16, wherein each said detector has an associated visual indicator.

18. An actuation device according to claim 17, wherein said visual indicator comprises alphabets or numerals on back illumination.

19. An actuation device according to claim 18, wherein each said object detector is arranged for emitting a visual acknowledgement signal when an object is detected as being present at said prescribed location of that object detector.

20. An actuation device according to claim 16, wherein the array defines a plurality of actuation locations, each actuation location coincides with the prescribed locations of the detectors, the actuation locations of the object detectors do not overlap.

21. An actuation device according to claim 16, wherein each of the object detectors is adapted for detecting the presence of a finger at the prescribed location of that detector for non-contact actuation operation.

22. An actuation device according to claim 16, wherein said actuation device is adapted for sequential operation of a plurality of keys by detecting sequential presence of a finger at a plurality of prescribed locations.

23. An actuation device according to claim 22, wherein said optical collector is adapted for collecting light scattered by the head portion of a finger after a collimated light from said optical source having impinged on said head portion of said finger.

24. An actuation device according to claim 23, wherein said optical source, the finger and said optical detector are arranged to form a closed optical detection loop when said finger is placed at said prescribed location whereat light emitted by the optical source being scattered by said finger and collected by said optical detector to complete said optical detection loop, said optical detection loop being opened when said finger is removed from said prescribed location.
